(19) United States
(12) Patent Application Publication
(10) Pub. No.: US 2012/0301626 A1
(43) Pub. Date: Nov. 29, 2012

(54) METHOD OF MAKING A COMPACT LAYER OF ENAMEL COATINGS ON MOULDED PRODUCTS

(76) Inventors: ALFONZ MORAVCÍK, Bratislava (SK); MARTIN MORAVCÍK, Bratislava (SK)

(21) Appl. No.: 13/476,604

(22) Filed: May 21, 2012

(30) Foreign Application Priority Data
May 24, 2011 (SK) PP 0043-2011
Aug. 19, 2011 (SK) PP 50036-2011

(51) Int. Cl. B05D 3/02

(52) U.S. Cl. 427/457

(57) ABSTRACT

An invention relates to application of enamel layers in the form of powder in the electric field and subsequent firing. A cleaned surface of a steel product is covered with a ground coat enamel layer in the form of powder in the electric field by an application gun until the layer reaches thickness of 100 to 150 μm, subsequently the electric field is interrupted in order to reduce a space charge around the metal product and in the same manner a minimum of another two layers of cover coat enamel powder is applied until thickness of the total enamel powder layer of minimum 750 μm is reached, whereas the electric field is interrupted each time between each steps of cover coat enamel powder application.

### TECHNICAL FIELD

An invention relates to a method of making a compact layer of enamel coatings also on moulded products by means of application of enamel powders in the electric field.

### STATE OF THE ART

At moulded products enamel coatings made by a method of application of enamel powders in the electric field, particularly by a two layer application—a ground coat layer plus a cover layer—of enamel powder in a single firing process exhibit defects in compactness. For the said reason, the products intended for higher stress corrosion, such as enamel bath tubs, bath basins, boilers, and the like, have to be provided with another enamel powder cover coat layer in a repeated firing process.

Experimentally, it has been found that especially in bi-layer systems (an enamel powder ground coat layer plus an enamel powder cover coat layer) of moulded products the enamel compactness after a firing process highly depends on thickness of the enamel powder layer. Therefore, it is necessary to make sufficiently thick enamel powder layers in the electric field in order to make enamel of approximate thickness of 250 μm after firing. Making sufficiently thick layer of enamel powder in the electric field is, however, hampered by formation of a space charge as a result of gathering of the charged enamel particles of identical polarity on a product surface.

In making an enamel layer a value of the space charge depends on charge conduction and that is given by the equation:

Q=Qₒ·e^{-t/R.C}

Q—Charge after time t [C]

Qₒ—Initial charge [C]

t—Time

R—Specific electrical resistance of the particle [Om]

C—Capacity [F]

e—Elementary charge (value=1.602176487(40)·10¹⁹ [C])

After reaching a marginal value of the space charge, further growth of thickness of the enamel powder layer on the product is discontinued, be it before a required value of thickness of the enamel powder layer on the product is reached.

After firing such product shows defects in the enamel coating caused by an insufficient layer of enamel powder. In particular, it relates to damage in compactness of the enamel coating, whereas the compactness of the enamel coating is a determining parameter in a protection function of the coating and it is an important quality sign.

### SUBJECT-MATTER OF THE INVENTION

The said shortcoming is eliminated by a method of making a compact layer of enamel coatings on moulded products by means of application of enamel layers in the form of powder in the electric field and following-up firing process, which essence is that a layer of ground coat enamel in the form of powder is applied on a cleaned surface of a steel product in the electric field by application guns until thickness of layer of 100-150 μm is reached, subsequently the electric field is interrupted in order to decrease the space charge around the metal product and in the same manner a minimum of two layers of the cover coat enamel powder is applied until the total layer of enamel powder of minimum 750 μm thick is reached, whereas the electric field is interrupted each time between each steps of cover coat enamel powder application.

According to a preferred embodiment the interruption of the electric field in proximity of the product can be reached by a move of the product to another application location.

A method of enamel powder application in the electric field under the invention is performed by an interruption of the electric field at scheduled time intervals, where during the said interruption the value of the space charge decreases, by which a condition to restore growth of the enamel powder layer thickness is made. By the said repeated interruption of the electric field and restoration of the coating process, which can be programmed into the production facilities, a possibility to obtain extraordinary thickness of the enamel powder layer and after its firing the expected compactness of the enamel coating are achieved.

According to a preferred embodiment overall thickness of the enamel powder layer can be 900 to 1000 μm.

Making enamel powder layers by a method of enamel powder application in the electric field can be performed on a fully automated production line consisting of several application cabins. In the first cabin, for example, making of a sufficient layer of the ground coat enamel powder is performed. In order to apply the sufficient layer of the ground coat enamel of thickness of 30 to 40 μm after firing, it is necessary to make a layer of ground coat enamel powder of thickness of 100 to 150 μm. In other e.g. four cabins making of the sufficient layer of cover coat enamel powder is performed. In order to make the sufficient cover coat enamel layer of thickness of about 250 μm after firing it is necessary to make a cover coat enamel powder layer of minimal thickness of 750 μm. The product can be placed on an overhead conveyor so it can smoothly pass through the said positions—cabins. The enamel powder layers on the product surface are formed as a result of Coulomb's forces. Adhesive forces in the enamel powder layer depend on specific electrical resistance of the powder, air humidity, intensity of the electric field at time of enamel powder charging or by prolonging enamel powder charging time. The forces that attract the powder to the product surface are subtle; they cease in time and weaken by leaking of the charge from particles. A strong bond of the layer and the substrate metal is achieved by firing in a continuous tunnel kiln at temperature of circa 800° C. to 840° C.

### EXEMPLARY EMBODIMENT OF THE INVENTION

### EXAMPLE 1

### Bath Tub Enamelling

After moulding, products require surface pre-treatment before enamelling. This phase primarily means cleaning the surface from oils, rust and other mechanical residue. The cleaning process is completely performed in an automated line, where drying is a final operation.

Layers of enamel powder were applied on the treated and cleaned surface of a steel bath tub in the electric field until necessary thickness of e.g. 900 μm was reached. Making of enamel powder layer of sufficient thickness by the method of enamel powder application in the electric field was performed on a fully automated line consisting of five application positions. Application of the first ground coat enamel layer was performed on the first application position and application of cover coat enamel layer was made on other four application positions. The product was placed on an overhead conveyor and continuously passed through the said positions. On the first application position the ground coat enamel powder was applied from an application gun in the electric field until required thickness of the ground coat enamel powder layer of approximately 100 μm was reached. After making the required layer of the ground coat enamel powder the application was discontinued and the product was moved to the second application position, whereby the electric field around the product was interrupted. On the second application position the cover coat enamel powder was applied in the electric filed by application guns until reaching the cover coat enamel powder layer approximately 150 to 250 μm thick. It took approximately 60 seconds to make such layer. Then, the application was interrupted and the product was moved to another application position. Other layers of the cover coat enamel powder were applied on the third to five positions in the same manner. Thickness of the enamel powder layer made on the product surface was 900 to 950 μm. A firm bond of the enamel powder layer and the substrate metal was reached by firing the product in a continuous tunnel kiln at temperature of 820° C. Thickness of the enamel layer was approximately 260 μm after firing.

1. A method of making a compact layer of enamel coatings on moulded products by applying enamel layers in the form of powder in the electric field and subsequent firing characterised in that a layer of ground coat enamel in the form of powder is applied on the cleaned surface of a steel product in the electric field by application guns until thickness of the layer reaches 100 to 150 μm, subsequently the electric field is interrupted in order to reduce a space charge around the metal product and in the same manner a minimum of two layers of cover coat enamel powder are applied until the total layer of enamel powder reaches thickness of minimum 750 μm, whereas the electric field is interrupted each time between each steps of cover coat enamel powder application.

2. A method of making a compact layer of enamel coatings on moulded products according to claim 1 characterised in that the interruption of the electric field around the product is carried out by moving the product to another application position.

3. A method of making a compact layer of enamel coatings on moulded products according to claim 1 characterised in that a total layer of enamel powder is 900 to 1000 μm.
